(19) United States
(12) Patent Application Publication
(10) Pub. No.: US 2026/0254077 A1
(43) Pub. Date: Aug. 27, 2026

(54) BATTERY MODULE

(71) Applicant: SAMSUNG SDI CO., LTD., Yongin-si (KR)

(72) Inventors: JONGYUL WOO, Yongin-si (KR); HYUNMYUNG LEE, Yongin-si (KR); MYUNGCHUL CHUN, Yongin-si (KR)

(73) Assignee: SAMSUNG SDI CO., LTD., Yongin-si (KR)

(21) Appl. No.: 19/534,962

(22) Filed: Feb. 10, 2026

(30) Foreign Application Priority Data
Feb. 21, 2025 (KR) 10-2025-0023201

(51) Int. Cl. H01M 50/682; A62C 3/16; A62C 31/00; H01M 50/209; H01M 50/271; H01M 50/507

(52) U.S. Cl. CPC H01M 50/682; A62C 3/16; A62C 31/00; H01M 50/209; H01M 50/271; H01M 50/507

(57) ABSTRACT

Provided is a battery module, including a plurality of cell units, each of which includes a plurality of battery cells arranged along a first direction and which are arranged in a second direction substantially perpendicular to the first direction, a plurality of busbars electrically coupling the plurality of battery cells to one another, a busbar holder supporting the plurality of busbars, and a flow path positioned in the busbar holder among the plurality of cell units, wherein the busbar holder includes a protection portion surrounding the flow path, and the protection portion has a plurality of openings formed in a direction of a plurality of battery cells.

### CROSS-REFERENCE TO RELATED APPLICATIONS

This present application claims priority to and the benefit under 35 U.S.C. § 119(a)-(d) of Korean Patent Application No. 10-2025-0023201, filed on Feb. 21, 2025, in the Korean Intellectual Property Office, the entire disclosure of which is incorporated herein by reference.

### FIELD

The disclosure relates to a battery module.

### BACKGROUND

Secondary batteries are batteries that can be charged and discharged, unlike primary batteries that cannot be recharged. Low-capacity secondary batteries are used in small, portable electronic devices such as smartphones, feature phones, laptops, digital cameras, and camcorders, while high-capacity secondary batteries are widely used as power sources for driving motors in hybrid cars, electric cars, or the like and as power storage batteries. These secondary batteries may include an electrode assembly including a positive electrode and a negative electrode, a case for accommodating the electrode assembly, and electrode terminals connected to the electrode assembly.

In some embodiments, an energy storage system is a system which may store surplus electricity or electricity produced using renewable energy. Spaces or facilities where energy storage systems are installed and operated should be provided with installations for preventing battery fires caused by electric shock, short circuits, external surges, or the like. There is an increasing demand for fire extinguishing systems for energy storage systems, which are capable of effectively suppressing a plurality of battery fires and enabling early suppression in the event a high-pressure fire.

The herein-described information disclosed in the background technology of the disclosure is only intended to improve understanding of the background of the disclosure and therefore may include information that does not constitute prior art.

### SUMMARY

An object of the disclosure is to provide a battery module with improved stability.

However, the technical problems to be solved by the disclosure are not limited to the problems described herein, and other problems not mentioned may be clearly understood by those skilled in the art from the disclosure described herein.

According to aspects of the disclosure, a battery module is disclosed, including: a plurality of cell units, each of which includes a plurality of battery cells arranged along a first direction and which are arranged in a second direction substantially perpendicular to the first direction; a plurality of busbars electrically coupling the plurality of battery cells to one another; a busbar holder supporting the plurality of busbars; and a flow path positioned in the busbar holder among the plurality of cell units, wherein the busbar holder includes a protection portion surrounding the flow path, and the protection portion has a plurality of openings formed in a direction of the plurality of battery cells.

According to embodiments, the flow path may be positioned above a space in which a plurality of battery cells are spaced apart from one another.

According to embodiments, each of the plurality of battery cells may include a case for accommodating an electrode assembly and a cap plate coupled to the case, and a lower surface of the protection portion may be positioned at a higher level than the cap plate.

According to embodiments, the plurality of openings may be arranged spaced apart from one another along the longitudinal direction of the flow path.

According to embodiments, the cap plate may include a vent, and the plurality of openings may be formed at a position corresponding to the cap plates of the plurality of battery cells.

According to embodiments, the plurality of openings may be positioned in at least one of an upper portion, a lower portion, a side portion, and a corner portion of the protection portion in the direction of the plurality of battery cells.

According to embodiments, at least two of the plurality of openings may be arranged on an outer side surface of the protection portion in a cross section of the protection portion which is substantially perpendicular to a longitudinal direction of the flow path.

According to embodiments, the protection portion may be in the shape of a square tube or a circular tube.

According to embodiments, a melting point of the protection portion may be higher than a melting point of the flow path.

According to embodiments, a fire extinguishing liquid may be supplied to the flow path, and in case that an event occurs in a cell among the plurality of battery cells, the fire extinguishing liquid may be supplied to the cell through an opening, which corresponds to the cell, among the plurality of openings.

According to aspects of the disclosure, a battery module is disclosed, including: a plurality of cell units, each of which includes a plurality of battery cells arranged along a first direction and which are arranged in a second direction substantially perpendicular to the first direction; a plurality of busbars electrically coupling the plurality of battery cells to one another; a busbar holder supporting the plurality of busbars; a flow path positioned in the busbar holder among the plurality of cell units; and an upper cover on the plurality of busbars, wherein the flow path is positioned above a space in which the plurality of battery cells are spaced apart from one another, and the busbar holder includes a protection portion which is spaced apart from the flow path, surrounds the flow path, and has a plurality of openings formed therein.

According to embodiments, the plurality of openings may be formed in a direction of the plurality of battery cells.

According to embodiments, the plurality of openings may be positioned in at least one of an upper portion, a lower portion, a side portion, a corner portion of the protection portion.

According to embodiments, at least two of the plurality of openings may be arranged on an outer side surface of the protection portion in a cross section of the protection portion which is substantially perpendicular to the longitudinal direction of the flow path.

According to embodiments, the protection portion may be in the shape of a square tube or a circular tube.

According to embodiments, each of the plurality of battery cells may include a case for accommodating an electrode assembly and a cap plate coupled to the case, and a lower surface of the protection portion may be positioned at a higher level than the cap plate.

According to embodiments, the plurality of openings may be arranged spaced apart from one another along the longitudinal direction of the flow path.

According to embodiments, the cap plate may include a vent, and the plurality of openings may be formed at a position corresponding to the cap plates of the plurality of battery cells.

According to embodiments, the flow path may be provided with fire extinguishing liquid.

According to embodiments, in case that an event occurs in a battery cell among the plurality of battery cells, the fire extinguishing liquid may be provided to the battery cell and the surrounding area of the battery cell through the openings.

### BRIEF DESCRIPTION OF THE DRAWINGS

The following drawings attached to the specification illustrate preferred embodiments of the disclosure and, together with the detailed description of the disclosure described herein, serve to further understand the technical idea of the disclosure; therefore, the disclosure should not be interpreted as being limited to matters described in such drawings:

FIG. 1 is a perspective view schematically illustrating an example of a battery module according to embodiments of the disclosure;

FIG. 2 is an exploded perspective view schematically illustrating an example of a battery module according to embodiments of the disclosure;

FIG. 3 is a perspective view schematically illustrating an example of a battery cell of the battery module of FIG. 1;

FIG. 4 is a cross-sectional view schematically illustrating an example of a cross section taken along line III-III′ of FIG. 3;

FIGS. 5A and 5B are perspective views schematically illustrating an example of a flow path and a protection portion of a battery module according to embodiments of the disclosure;

FIG. 6 is an enlarged view schematically illustrating a part including a flow path and a protection portion of a battery module according to embodiments of the disclosure;

FIG. 7A is a cross-sectional view schematically illustrating an example of a cross section taken along by line A-A′ of FIG. 1;

FIG. 7B is a cross-sectional view schematically illustrating another example of the cross section taken along by line A-A′ of FIG. 1;

FIG. 8 is a perspective view schematically illustrating an example of a battery cell, a flow path, and a protection portion of a battery module according to embodiments of the disclosure; and

FIG. 9 is a graph showing the results of a heat propagation evaluation of a battery module according to embodiments of the disclosure.

### DETAILED DESCRIPTION

Hereinafter, preferred embodiments of the disclosure will be described in detail with reference to the attached drawings. Prior to this, terms or words used in the specification and claims should not be interpreted as limited to usual or dictionary meanings and should be interpreted as meanings and concepts that conform to the technical idea of the disclosure based on the principle that the inventor may appropriately define the concept of a term to explain his or her own disclosure in the best way. Therefore, the embodiments described in the specification and the configurations illustrated in the drawings are only some of the most preferred embodiments of the disclosure and do not represent all the technical idea of the disclosure, and it should be understood that there may be various equivalents and modified examples that may replace them at the time of filing the application.

In some embodiments, when used herein, the words “comprise”, “include” and/or “comprising”, “including” specify the presence of stated features, numbers, steps, operations, members, components and/or groups thereof, but do not preclude the presence or addition of one or more other features, numbers, operations, members, components and/or groups thereof.

In some embodiments, to aid understanding of the disclosure, the attached drawings are not drawn to the actual scale and the dimensions of some components may be exaggerated. In some different embodiments, the same reference numbers may be assigned to the same components.

Although the terms first, second, or the like are used to describe various components, these components are not limited by the terms. These terms are only used to distinguish a component from another, and unless otherwise specifically stated, it is of course the case that a first component may also be a second component.

Throughout the specification, unless otherwise specifically stated, each component may be singular or plural.

Any configuration being arranged “at the top (or bottom) of” a component or “on (or below)” a component may mean not only that any configuration is arranged in contact with an upper surface (or a lower surface) of the component, but also that other configurations may be interposed between the component and any configuration arranged on (or below) the component.

In some embodiments, when it is described that a component is “connected,” “coupled,” or “linked” to another component, it should be understood that the components may be directly connected or linked to one another, but that other components may also be “interposed” between each component, or that each component may be “connected,” “coupled,” or “linked” through other components. In some embodiments, when we say that a part is electrically coupled to another part, this may include not only cases where the parts are directly connected to one another, but also cases where the parts are connected to one another with another element in between.

Hereinafter, embodiments of the disclosure will be described in detail with reference to the attached drawings. When describing with reference to the drawings, identical or corresponding components will be given the same drawing reference numerals.

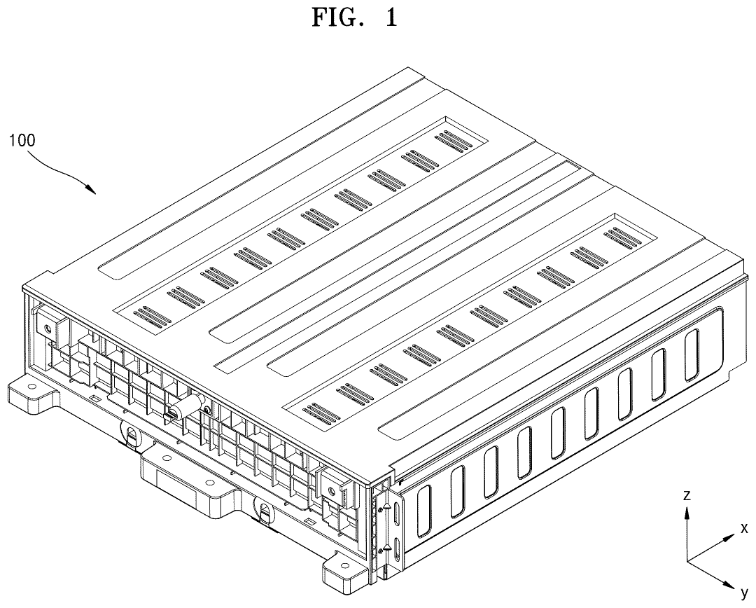

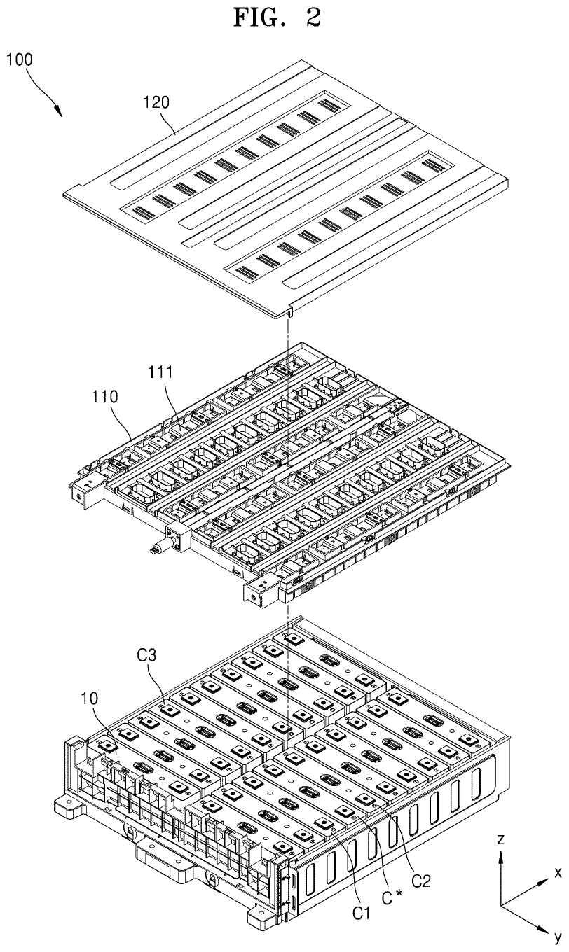

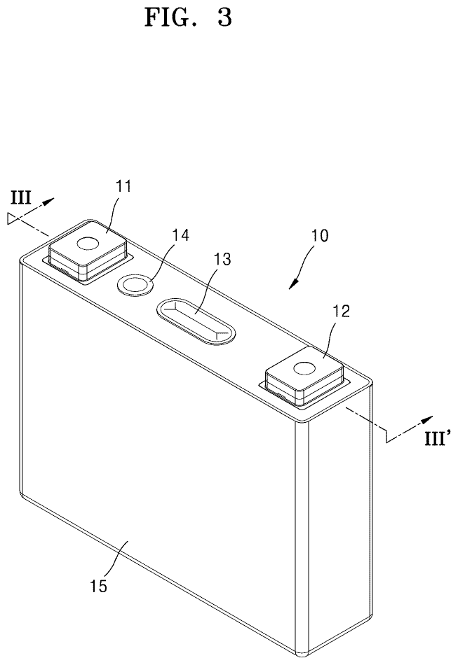

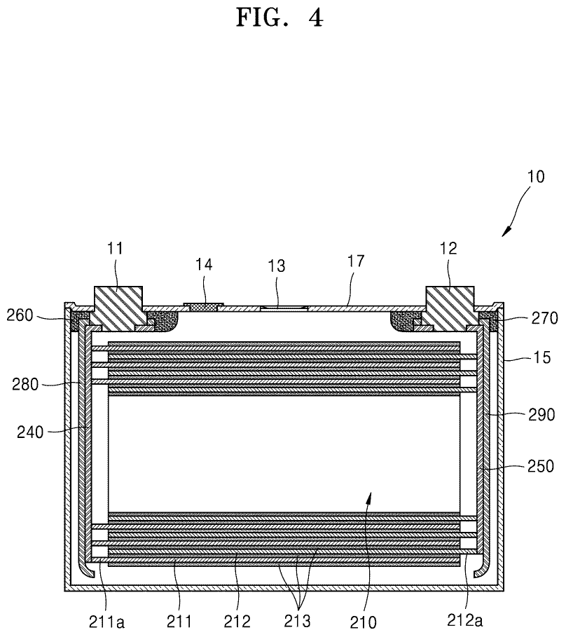

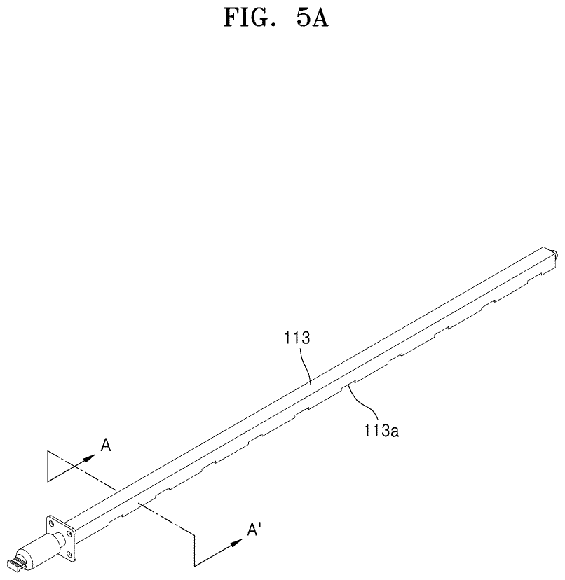

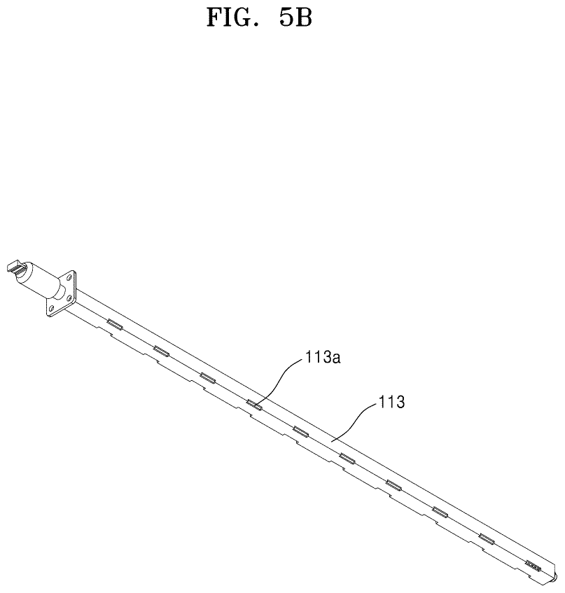

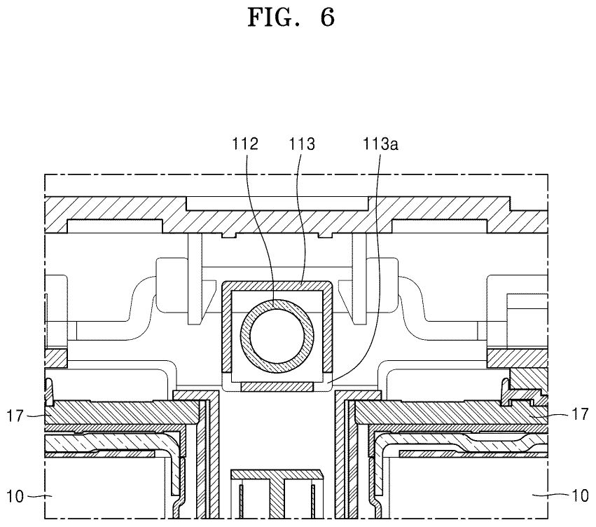

FIG. 1 is a perspective view schematically illustrating an example of a battery module according to embodiments of the disclosure, and FIG. 2 is an exploded perspective view schematically illustrating an example of a battery module according to embodiments of the disclosure. FIG. 3 is a perspective view schematically illustrating an example of a battery cell of the battery module of FIG. 1, and FIG. 4 is a cross-sectional view schematically illustrating an example of a cross section taken along line III-III′ of FIG. 3. FIGS. 5A and 5B are perspective views schematically illustrating an example of a flow path and a protection portion of a battery module according to embodiments of the disclosure, and FIG. 6 is an enlarged view schematically illustrating a part including a flow path and a protection portion of a battery module according to embodiments of the disclosure.

Referring to FIGS. 1, 2, 5A, 5B, and 6, a battery module 100 of the disclosure according to an aspect includes a plurality of cell units 1110, each of which includes a plurality of battery cells 10 arranged along a first direction x and which are arranged in a second direction y perpendicular to the first direction; a plurality of busbars 111 electrically coupling the plurality of battery cells 10 to one another; a busbar holder 110 supporting the plurality of busbars 111; and a flow path 112 positioned in the busbar holder 110 among the plurality of cell units 1110, wherein the busbar holder 110 includes a protection portion 113 surrounding the flow path 112, and the protection portion 113 may have a plurality of openings 113a formed in the direction of the plurality of battery cells 10.

Referring to FIGS. 3 and 4, a battery cell 10 may include a battery case 15, an electrode assembly 210 accommodated within the battery case 15, and an electrolyte. The electrode assembly 210 and the electrolyte may react electrochemically to generate energy.

A side of the battery cell 10 may be provided with terminal portions 11 and 12 each electrically coupled to a connection tab 20, a vent 13 as a passage for discharging gas generated internally, and an electrolyte injection port 14 for injecting an electrolyte into the battery case 15. The terminal portions 11 and 12 of a battery cell 10 may be a first terminal 11 and a second terminal 12 having different polarities. In some embodiments, in case that the first terminal 11 is a positive electrode terminal, the second terminal 12 may be a negative electrode terminal, and conversely, in case that the first terminal 11 is a negative electrode terminal, the second terminal 12 may be a positive electrode terminal. That is, the first terminal 11 and the second terminal 12 may include different electrical polarities and each may not be limited to a specific polarity.

The terminal portions 11 and 12 of battery cells 10, which are adjacent to one another, may be electrically connected in series and/or in parallel by means of a connection tab. In some embodiments, a first terminal 11 of a battery cell 10 may be electrically coupled to a second terminal 12 of another adjacent battery cell 10 through a connection tab, and a second terminal 12 of the battery cell 10 may be electrically coupled to a first terminal 11 of another adjacent battery cell 10 through another connection tab.

In some embodiments, although a serial connection is exemplarily described in FIGS. 1, 2, and 8, it is not limited to this structure and various connection structures may be adopted as needed. In some embodiments, the number and arrangement of battery cells are not limited to the structures illustrated in FIGS. 1, 2, and 8 and may be changed as needed.

A plurality of battery cells 10 may be arranged in a direction x, so that the wide surfaces of the battery cells 10 face one another, and the plurality of battery cells 10, which are arranged, may be accommodated by a housing.

The housing may include a pair of end plates each facing a wide surface of a battery cell 10, a side plate connecting the pair of end plates to one another, and a bottom plate.

The side plate may support a side surface of a battery cell 10, and the bottom plate may support a bottom surface of a battery cell 10. In some embodiments, the pair of end plates, the side plate and the bottom plate each may be connected by a member such as a bolt.

In some embodiments, a battery cell 10 according to embodiments of the disclosure may include at least one electrode assembly 210, in which a first electrode plate 211 and a second electrode plate 212 including a plurality of sheets are alternately laminated with a separator 213 interposed therebetween, and a case 15 in which the electrode assembly 210 is accommodated.

The first electrode plate 211 and the second electrode plate 212 of a battery cell 10 may have different polarities. In some embodiments, in case that the first electrode plate 211 is a positive electrode, the second electrode plate 212 may be a negative electrode, and conversely, in case that the first electrode plate 211 is a negative electrode, the second electrode plate 212 may be a positive electrode. That is, the first electrode plate 211 and the second electrode plate 212 may include different electrical polarities and each may not be limited to a specific polarity.

A battery cell 10 according to embodiments is described as a square lithium ion battery cell as an example. However, the disclosure is not limited thereto, and the disclosure may be applied to various types of battery cells such as lithium polymer battery cells or cylindrical battery cells.

The first electrode plate 211 and the second electrode plate 212 may include a coated portion, which is an area where an active material is applied to a current collector including a metal foil of a thin plate, and a first non-coated portion 211a and a second non-coated portion 212a, which are areas where the active materials are not applied.

The electrode assembly 210 may include a structure in which a first electrode plate 211 and a second electrode plate 212 including a plurality of sheets are alternately laminated with a separator 213 in between. However, the disclosure is not limited thereto, and the first electrode plate 211 and the second electrode plate 212 may be wound with a separator 213, which is an insulator, interposed therebetween.

The case 15 may form the overall appearance of a battery cell 10 and may include a conductive metal such as aluminum, an aluminum alloy, or nickel-plated steel. In some embodiments, the case 15 may provide a space in which the electrode assembly 210 is accommodated.

The battery cell 10 may include a cap plate 17 covering an opening of the case 15, and the case 15 and the cap plate 17 each may include a conductive material. In this regard, the first terminal 11 and the second terminal 12 electrically coupled to the first electrode plate 211 or the second electrode plate 212 may be installed to protrude outward by penetrating the cap plate 17.

In some embodiments, the outer main surface of an upper pillar of each of the first terminal 11 and the second terminal 12 protruding outward from the cap plate 17 may be threaded and may be fixed to the cap plate 17 with a nut.

However, the disclosure is not limited thereto, and the first terminal 11 and the second terminal 12 each may include a rivet structure and be riveted or may be welded to the cap plate 17.

In some embodiments, the cap plate 17 may include a thin plate to be coupled to the opening of the case 15, and an electrolyte injection port 14 into which a sealing plug may be installed may be formed in the cap plate 17, and a vent 13 having a notch may be installed.

The first terminal 11 and the second terminal 12 may be electrically connected to a current collector including a first current collector 240 and a second current collector 250 which are welded to a first non-coated portion 211a of the first electrode plate and a second non-coated portion 212a of the second electrode plate.

In some embodiments, the first terminal 11 and the second terminal 12 may be welded to the first current collector 240 and the second current collector 250, respectively. However, the disclosure is not limited thereto, and the first terminal 11 and the second terminal 12 and the first current collector 240 and the second current collector 250 may be formed by being integrally coupled to one another.

In some embodiments, an insulation member may be installed between the electrode assembly 210 and the cap plate 17. In this regard, the insulation member may include a first lower insulation member 260 and a second lower insulation member 270, and each of the first lower insulation member 260 and the second lower insulation member 270 may be installed between the electrode assembly 210 and the cap plate 17.

In some embodiments, an end of a separation member which may be installed facing a side surface of the electrode assembly 210 may be installed between the insulation member and the first terminal 11 and the second terminal 12. In this regard, the separation member may include a first separation member 280 and a second separation member 290.

Accordingly, an end of the first separation member 280 and an end of the second separation member 290 which may be installed facing a side surface of the electrode assembly 210 may be installed between the first lower insulation member 260 and the second lower insulation member 270 and the first terminal 11 and the second terminal 12.

Finally, the first terminal 11 and the second terminal 12 welded to the first current collector 240 and the second current collector 250 may be coupled to the first lower insulation member 260 and the second lower insulation member 270 and an end of the first separation member 280 and an end of the second separation member 290.

The busbar 111 may serve to electrically couple terminals of adjacent battery cells 10 to one another, and the busbar holder 110 may be configured to support these busbars 111. The busbar holder 110 of a battery module according to embodiments of the disclosure may include a protection portion 113 surrounding the flow path 112, so that the flow path 112 may be stably fixed within the battery module 100 and the height at which the flow path 112 is positioned may be stably maintained.

The flow path 112 is a tube through which fire extinguishing liquid flows and may be a component which moves and injects the fire extinguishing liquid in case that an event such as fire, explosion, or thermal runaway occurs in a battery cell 10. Referring to FIG. 2 and FIG. 6, the flow path 112 may be positioned in a busbar holder 110 supporting a plurality of busbars 111 and may be positioned above a space in which a plurality of battery cells 10 are spaced apart from one another by being surrounded by a protection portion 113 included in the busbar holder 110.

According to embodiments, each of the plurality of battery cells 10 may include a case 15 for accommodating an electrode assembly and a cap plate 17 coupled to the case 15, and the lower surface of the protection portion 113 may be positioned at a higher level than the cap plate 17.

According to the configuration, in case that an event occurs above or outside a plurality of battery cells 10 of a battery module 100 and heat or flames are generated, the heat may be transferred through an opening 113a formed in a protection portion 113 in a direction in which the event has occurred, whereby a nearby flow path 112 corresponding to the opening 113a may melt and fire extinguishing liquid may be injected.

In some embodiments, in case that an event occurs in a specific battery cell 10 among a plurality of battery cells 10, extraneous matter or damage may occur inside the battery module 100. The extraneous matter or damage may be a broken extraneous matter or damage of a case 15, a cap plate 17 of a battery cell 10 and welding portions thereof. According to the configuration, fire extinguishing liquid may be effectively injected in the direction of the case 15, the cap plate 17 of the battery cell 10 and the welding portions thereof, thereby preventing heat diffusion caused by the damage, which may be effective in improving the stability of the battery module 100.

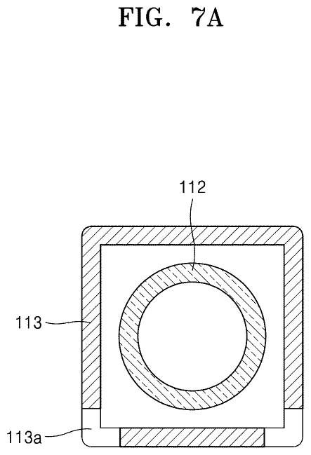

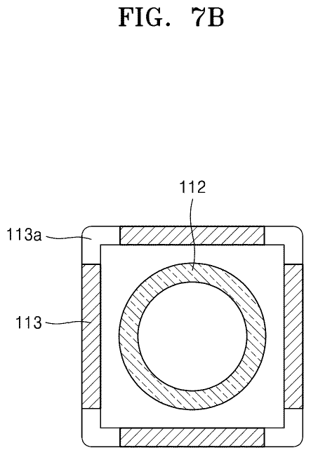

FIG. 7A is a cross-sectional view schematically illustrating an example of a cross section taken along by line A-A′ of FIG. 1, and FIG. 7B is a cross-sectional view schematically illustrating another example of the cross section taken along by line A-A′ of FIG. 1.

The protection portion 113 is a tube which surrounds the flow path 112, and the protection portion 113 may include a plurality of openings 113a formed in the direction of a plurality of battery cells 10. Accordingly, in case that an event such as fire, explosion, or thermal runaway occurs in a battery cell 10, the heat may be transferred through a plurality of openings 113a in the direction of the battery cell 10, and a nearby flow path 112 corresponding to each of the plurality of openings 113a may melt, thereby injecting fire extinguishing liquid intensively in the direction of the battery cell 10 where the event has occurred and the surrounding area thereof. This may minimize heat transfer to adjacent battery cells or prevent thermal runaway from occurring, thereby ensuring stability.

Referring to FIGS. 7A and 7B, according to embodiments, the plurality of openings 113a may be positioned in at least one of an upper portion, a lower portion, a side portion, and a corner portion of the protection portion 113 in the direction of the plurality of battery cells 10. In some embodiments, at least two of the plurality of openings 113a may be arranged on an outer side surface of the protection portion 113 in a cross section of the protection portion 113 perpendicular to the longitudinal direction of the flow path 112.

As described herein, at least two of the plurality of openings 113a may be arranged at various positions, which may be effective in supplying fire extinguishing liquid to various positions where events may occur in battery cells 10 or battery modules 100. In some embodiments, even if an event occurs in a plurality of battery cells 10 rather than just a specific battery cell 10, causing thermal runaway to occur simultaneously, it may be effective to supply fire extinguishing liquid to a plurality of event occurrence positions.

In some embodiments, heat or flames may be transferred to the interior of the battery module 100, such as the upper portion of a battery cell 10 and the surrounding area thereof, by the occurrence of an event in a specific battery cell 10. Although not limited thereto, in case that a plurality of openings 113a are positioned at a lower portion, a side portion and a corner portion of the protection portion 113 in the direction of a plurality of battery cells 10 as in embodiments of the disclosure, fire extinguishing liquid may be injected at various positions in the direction of a battery cell 10 where an event has occurred, which may be effective in improving the stability of the battery module 100.

In some embodiments, in case that an event occurs in a specific battery cell 10 among a plurality of battery cells 10, extraneous matter or damage may occur inside the battery module 100. The extraneous matter or damage may be a broken extraneous matter or damage of the case 15, the cap plate 17 of the battery cell 10 and the welding portions thereof. According to the configuration, a plurality of openings 113a may be positioned in at least one of an upper portion, a lower portion, a side portion, and a corner portion of the protection portion 113 and in the direction of a plurality of battery cells 10, so that fire extinguishing liquid may be injected at various positions, thereby preventing or minimizing heat diffusion due to extraneous matter or damage inside the battery module 100, which may be effective in improving the stability of the battery module 100.

In some embodiments, the shapes of the plurality of openings 113a may be configured in polygons, narrow and long slit shapes, circles, ovals, long holes, or the like, but are not limited thereto.

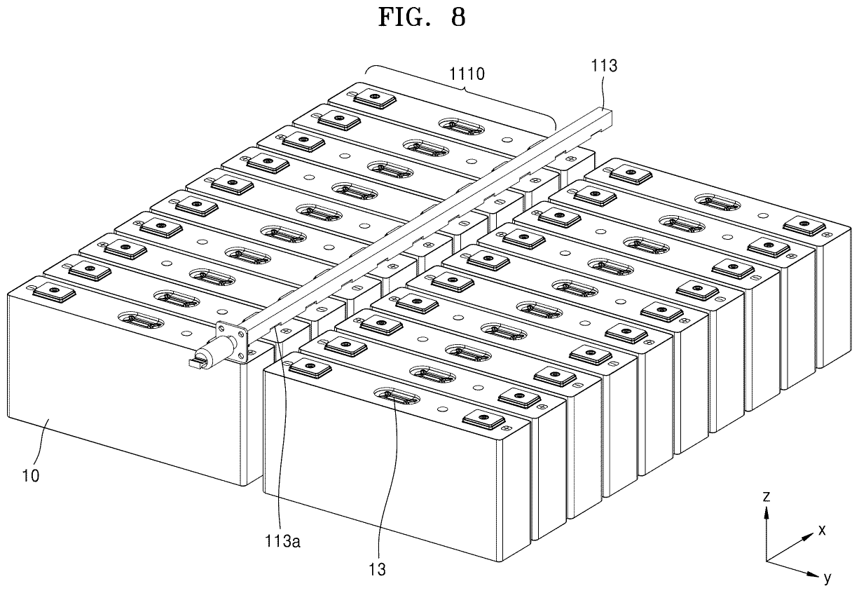

FIG. 8 is a perspective view schematically illustrating an example of a battery cell, a flow path, and a protection portion of a battery module according to embodiments of the disclosure.

Referring to FIGS. 5A, 5B, and 8, the plurality of openings 113a may be arranged spaced apart from one another along the longitudinal direction of the flow path 112. The space in which the plurality of openings 113a are spaced apart from one another may be adjusted according to the sizes of the plurality of openings 113a, and the sizes of the openings 113a may be adjusted according to the amount of fire extinguishing liquid to be injected. As described herein, because the battery module 100 according to embodiments of the disclosure may have a plurality of openings 113a arranged in a flow path 112, even if an event such as fire or explosion occurs in a specific battery cell, fire extinguishing liquid may be injected intensively in the direction of the battery cell 10 where the event has occurred and the surrounding area thereof. This may increase extinguishing efficiency, thereby further improving the stability of the battery module 100.

In some embodiments, according to embodiments, the cap plate 17 of a battery cell 10 may include a vent 13, and the plurality of openings 113a may be formed at positions corresponding to the cap plates 17 of the plurality of battery cells 10. In case that thermal runaway occurs in a specific battery cell 10, high-temperature gas and flames may be discharged from the vent 13. As a result, the flow path 112 exposed by an opening 113a formed in a protection portion 113 at a position corresponding to a cap plate 17 including a vent 13 may melt, so that fire extinguishing liquid may be injected from the flow path 112, thereby extinguishing the fire caused by thermal runaway occurring in the specific battery cell 10.

The protection portion 113 may be in the shape of a square tube or a circular tube. The square tube may be a square tube in the shape of a polygon having cross sections of various shapes, and the circular tube may be a tube in the shape of a circle or an oval, but this is not limited thereto.

In some embodiments, the melting point of the protection portion 113 may be higher than the melting point of the flow path 112 The protection portion 113 may be configured to surround and protect the flow path 112 and may use a material having a higher melting point than the flow path 112 to prevent the flow path 112 from being lost due to heat, flame, or the like.

Although not limited thereto, the melting point of the protection portion 113 may be higher than the temperature at which thermal runaway occurs in the battery module 100. In some embodiments, the melting point of the protection portion 113 may be 800° C. or higher, 900° C. or higher, or 1000° C. or higher. Accordingly, the material of the protection portion 113 may include a material having a high melting point, and any material may be used as long as the melting point of the protection portion 113 is higher than the temperature at which thermal runaway occurs in the battery module 100 and the protection portion 113 does not melt even when thermal runaway occurs in the battery module 100.

The flow path 112 may be supplied with fire extinguishing liquid, and in case that an event occurs in a battery cell 10 among the plurality of battery cells 10, the fire extinguishing liquid may be supplied in the direction of the battery cell 10 through an opening 113a, which corresponds to the battery cell 10, among the plurality of openings 113a formed in the protection portion 113 surrounding the flow path 112. In some embodiments, in case that an event occurs in a battery cell 10 among a plurality of battery cells 10, through an opening 113a formed in the direction of the battery cell 10 where the event has occurred, an exposed portion of the flow path 112 may melt due to heat and flame. This may cause fire extinguishing liquid supplied to the flow path 112 to be injected in the direction of the battery cell 10 where the event has occurred, thereby extinguishing the fire occurring in the specific battery cell 10.

In some embodiments, fire extinguishing liquid supplied to the flow path 112 may include halogenated carbon which absorbs heat through latent heat of vaporization to cool a battery cell 10. In some embodiments, fire extinguishing liquid may include a suffocating agent, such as a solid aerosol, which extinguishes fire by blocking oxygen, or any commonly used fire extinguishing liquid, such as water, may be adopted.

Referring to FIGS. 1, 2, 5A, 5B and 6, a battery module 100 of the disclosure according to another aspect may include: a plurality of cell units 1110, each of which includes a plurality of battery cells 10 arranged along a first direction x and which are arranged in a second direction y perpendicular to the first direction x; a plurality of busbars 111 electrically coupling the plurality of battery cells 10 to one another; a busbar holder 110 supporting the plurality of busbars 111; a flow path 112 positioned in the busbar holder 110 among the plurality of cell units 1110; and an upper cover 120 on the plurality of busbars 111, wherein the flow path 112 may be positioned above a space in which the plurality of battery cells 10 are spaced apart from one another, and the busbar holder 110 may include a protection portion 113 spaced apart from the flow path 112, surrounding the flow path 112, and having a plurality of openings 113a formed therein.

An upper cover 120 may form an internal space of a battery module 100 by coupling a plurality of battery cells 10 to a housing or the like and protect the internal configuration of the battery module 100, such as a plurality of battery cells 10, a plurality of cell units 1110, and a plurality of busbars 111 inside the battery module 100, from mechanical shock, thermal shock, or the like.

Because the flow path 112 is positioned in a busbar holder 110 which supports a plurality of busbars 111, heat and flames may be prevented from being transferred to the upper cover 120 depending on the positions of a plurality of openings 113a formed in the protection portion 113 which surrounds the flow path 112.

In some embodiments, in case that an event occurs above or inside of the battery module 100, or at a position in a direction adjacent to the upper cover 120, so that heat or flames are generated, the heat may be transferred through an opening 113a of the protection portion 113 formed in the direction of the occurrence of the event, so that a nearby flow path 112 corresponding to the opening 113a may melt and inject fire extinguishing liquid.

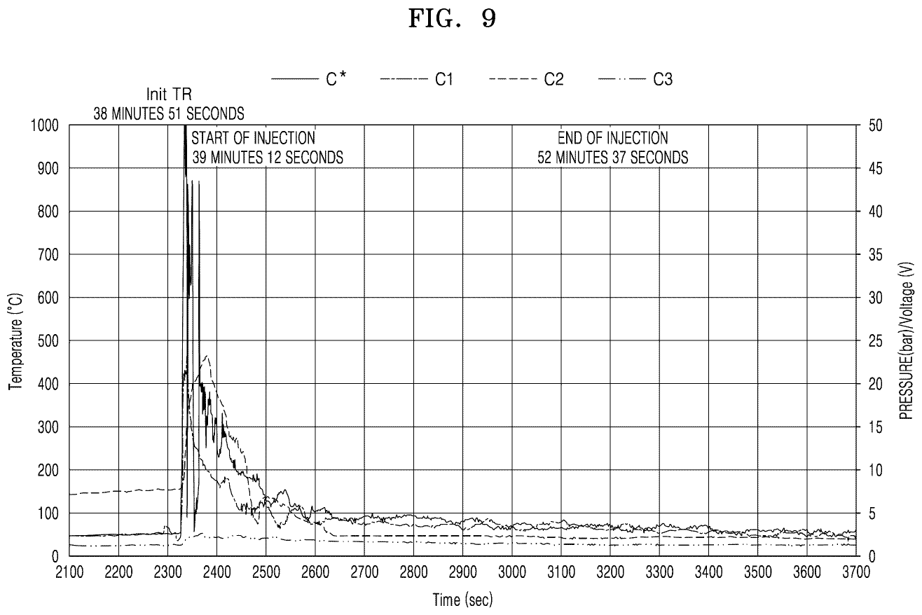

FIG. 9 is a graph showing the results of a heat propagation evaluation of a battery module according to embodiments of the disclosure.

To evaluate the stability of the battery module 100, a heat propagation evaluation of the battery module 100 according to embodiments of the disclosure was conducted. The battery module 100 was manufactured as a simple module of 2P10S, which consists of 2 parallel and 10 series battery cells 10. A 178Ah cell (4.11V, 145 A, 15.2 A cut-off) was used as a battery cell 10 included in the battery module 100, and a test was conducted after applying potting liquid to a busbar 111.
Inter-cell distance: 4 mm
Insulation thickness: 1 T (1mm)
Fire extinguishing liquid (Novec) micro-injection once
Cell voltage: 4.09V
Module voltage: 40.9V

Referring to FIG. 2 and FIG. 9, after thermal runaway was induced in a battery cell C* among the battery cells 10 of the simple module, the change in temperature over time was confirmed for, a left-adjacent battery cell C1, a right-adjacent battery cell C2, and a rear-adjacent battery cell C3 with respect to the event battery cell C*, which has induced the thermal runaway.

In the case of the event battery cell C*, the temperature rose to or over 1000° C. with thermal runaway, and in the case of the right-adjacent battery cell C2 the left-adjacent battery cell C1, each temperature rose to 400 to 500° C., and no thermal runaway has occurred after fire extinguishing liquid was injected. In some embodiments, in the case of the rear-adjacent battery cell C3 across the flow path surrounding the protection portion 113, the temperature rise was less than or equal to 100° C. and no thermal runaway has occurred.

According to embodiments, fire extinguishing liquid may be injected intensively in the direction of a battery cell where a problem has occurred and the surrounding area of the battery cell, thereby preventing thermal runaway from spreading throughout the entire battery module, which improves stability.

According to embodiments, the battery module of the disclosure may immediately inject fire extinguishing liquid in the direction of a battery in which a problem has occurred by positioning the flow path in the busbar holder and may also effectively inject fire extinguishing liquid in the direction of a case and cap plate of a battery cell, thereby improving stability.

According to embodiments, the battery module of the disclosure may include a protection portion which surrounds the flow path and has a plurality of openings formed therein, so that in case that an event such as fire or explosion occurs in a battery cell, a portion of the flow path, which is directly exposed to heat and flames, may be minimized, thereby improving safety.

However, the effects obtainable through the disclosure are not limited to the effects described herein, and other technical effects not mentioned will be clearly understood by those skilled in the art from the disclosure described herein.

Although the disclosure has been described herein by means of limited embodiments and drawings, the disclosure is not limited thereto, and it is obvious that various modifications and variations are possible within the equivalent scope of the technical idea of the disclosure and the claims to be described herein by a person skilled in the art to which the disclosure pertains.

What is claimed is:

1. A battery module, comprising:
a plurality of cell units, each of which includes a plurality of battery cells arranged along a first direction and which are arranged in a second direction substantially perpendicular to the first direction;
a plurality of busbars electrically coupling the plurality of battery cells to one another;
a busbar holder supporting the plurality of busbars; and
a flow path positioned in the busbar holder among the plurality of cell units, wherein
the busbar holder includes a protection portion surrounding the flow path, and
the protection portion includes a plurality of openings formed in a direction of a plurality of battery cells.

2. The battery module of claim 1, wherein
the flow path is positioned above a space in which a plurality of battery cells are spaced apart from one another.

3. The battery module of claim 1, wherein
each of the plurality of battery cells includes a case for accommodating an electrode assembly and a cap plate coupled to the case, and
a lower surface of the protection portion is positioned at a higher level than the cap plate.

4. The battery module of claim 3, wherein
the plurality of openings are arranged spaced apart from one another along a longitudinal direction of the flow path.

5. The battery module of claim 4, wherein
the cap plate includes a vent, and
the plurality of openings are formed at positions corresponding to cap plates of the plurality of battery cells.

6. The battery module of claim 1, wherein
the plurality of openings are positioned in at least one of an upper portion, a lower portion, a side portion, and a corner portion of the protection portion in the direction of the plurality of battery cells.

7. The battery module of claim 1, wherein
at least two of the plurality of openings are arranged on an outer side surface of the protection portion in a cross section of the protection portion which is substantially perpendicular to a longitudinal direction of the flow path.

8. The battery module of claim 1, wherein
the protection portion is in a shape of a square tube or a circular tube.

9. The battery module of claim 1, wherein
a melting point of the protection portion is higher than a melting point of the flow path.

10. The battery module of claim 1, wherein
the flow path is supplied with fire extinguishing liquid, and
in case that an event occurs in a battery cell among the plurality of battery cells, the fire extinguishing liquid is supplied to the battery cell through an opening, which corresponds to the battery cell, among the plurality of openings.

11. A battery module, comprising:
a plurality of cell units, each of which includes a plurality of battery cells arranged along a first direction and which are arranged in a second direction substantially perpendicular to the first direction;
a plurality of busbars electrically coupling the plurality of battery cells to one another;
a busbar holder supporting the plurality of busbars;
a flow path positioned in the busbar holder among the plurality of cell units; and
an upper cover on the plurality of busbars, wherein
the flow path is positioned above a space in which a plurality of battery cells are spaced apart from one another, and
the busbar holder includes a protection portion which is spaced apart from the flow path, surrounds the flow path, and has a plurality of openings formed therein.

12. The battery module of claim 11, wherein
the plurality of openings are formed in a direction of the plurality of battery cells.

13. The battery module of claim 12, wherein
the plurality of openings are positioned in at least one of an upper portion, a lower portion, a side portion, and a corner portion of the protection portion.

14. The battery module of claim 12, wherein
at least two of the plurality of openings are arranged on an outer side surface of the protection portion in a cross section of the protection portion which is substantially perpendicular to a longitudinal direction of the flow path.

15. The battery module of claim 11, wherein
the protection portion is in a shape of a square tube or a circular tube.

16. The battery module of claim 11, wherein
each of the plurality of battery cells includes a case for accommodating an electrode assembly and a cap plate coupled to the case, and
a lower surface of the protection portion is positioned at a higher level than the cap plate.

17. The battery module of claim 16, wherein
the plurality of openings are arranged spaced apart from one another along a longitudinal direction of the flow path.

18. The battery module of claim 16, wherein
the cap plate includes a vent, and
the plurality of openings are formed at positions corresponding to cap plates of the plurality of battery cells.

19. The battery module of claim 11, wherein
the flow path is supplied with fire extinguishing liquid.

20. The battery module of claim 19, wherein
in case that an event occurs in a battery cell among the plurality of battery cells, the fire extinguishing liquid is supplied to the battery cell and a surrounding area of the battery cell through the opening.
